(19) United States
(12) Patent Application Publication
(10) Pub. No.: US 2011/0056518 A1
(43) Pub. Date: Mar. 10, 2011

(54) Cleaning and/or Hair Gathering Apparatus, Method, and Design

(76) Inventors: Nancy J. Miller, Spokane Valley, WA (US); Cherly L. Adams, Cheney, WA (US)

(21) Appl. No.: 12/876,877

(22) Filed: Sep. 7, 2010

Related U.S. Application Data
(60) Provisional application No. 61/240,309, filed on Sep. 8, 2009.

(51) Int. Cl. B08B 1/00

(52) U.S. Cl. 134/6; 401/261

(57) ABSTRACT

The present disclosure provides apparatuses for cleaning and/or hair gathering. The devices can include first and second components configured to form a liquid dispenser and define a reservoir when operatively engaged. The second component can be configured as a multi-layered absorbent pad wherein one of the layers can comprise a substantially rigid, porous, and/or thick material, and another layer can comprise a less rigid, less porous, and/or thinner layer than the one layer. The present method provides for applying pressure to within a liquid-dispensing reservoir to force liquid from the reservoir to one substantially rigid, porous, and/or thick layer and then to another less rigid, less porous, and/or thinner layer of a multi-layered absorbent pad. The second layer of the multi-layered absorbent pad can be applied to materials for cleaning and/or hair gathering.

### CROSS REFERENCE TO RELATED APPLICATION

This application claims priority to U.S. Provisional Patent Application Ser. No. 61/240,309 which was filed on Sep. 8, 2009, the entirety of which is incorporated by reference herein.

### TECHNICAL FIELD

The present disclosure provides an apparatus, method, and design for cleaning and/or hair gathering.

### BACKGROUND

The accumulation of pet hair is a common problem for pet owners and those who have pets visiting their home. Individuals purchase many products to assist them in removing hair from their furniture and carpet but many of these products are inefficient and expensive to purchase. One product historically used for removing pet hair is the vacuum cleaner. The vacuum cleaner is expensive and has a tendency to miss some of the hair trapped on the furniture. Other devices use adhesive tapes or rollers that quickly fill with hair and must be replaced often. Some products currently on the market cause a portion of the pet hair that is being collected to be expelled from the furniture or carpet into the surrounding air.

Additionally, the removal of stains and odors from carpet and/or furniture has historically been a common problem. There are many liquid stain remover applicators available but some or all of these applicators are expensive and/or inefficient.

### SUMMARY

Embodiments of the present disclosure provide apparatuses for cleaning of, and/or hair removal from furniture and other materials. The apparatuses can include first and second components configured to form a liquid dispenser and define a reservoir when operatively engaged. The second component can be configured as a multi-layered absorbent pad. The second component can be configured to have at least two layers, one layer comprising a substantially rigid material and another layer comprising a less rigid material than the first layer.

Embodiments of the present disclosure can provide cleaning and/or hair gathering methods as well. Example implementations of the methods can include applying pressure to within a liquid-dispensing reservoir to force liquid from the reservoir to one substantially rigid layer and then to another less rigid layer of a multi-layered absorbent pad. The multi-layered absorbent pad can be used to apply liquid to material to be cleaned.

Embodiments of the present disclosure can provide designs for cleaning of, and/or hair removal from furniture and other materials.

### BRIEF DESCRIPTION OF THE DRAWINGS

Embodiments of the disclosure are described below with reference to the following accompanying drawings.

FIG. 1 is a cross sectional view of an illustrative reservoir and multi-layered absorbent pad according to an embodiment.

FIG. 2 is a cross sectional view of an illustrative reservoir with an opening and a cap according to an embodiment.

FIG. 3 is another view of an illustrative reservoir with one-way-opening slits according to an embodiment.

FIG. 4 is a cross sectional view of an illustrative multi-layered absorbent pad according to an embodiment.

FIG. 5 is a cross sectional view of an illustrative reservoir and a cross sectional view of an illustrative multi-layered absorbent pad according to an embodiment.

FIG. 6 is a cross sectional view of an illustrative reservoir with a flexible biased member and demarcations according to an embodiment.

FIG. 6A is a magnified cross sectional view of an illustrative flexible biased member according to an embodiment.

FIG. 7 is a cross sectional view of an illustrative multi-layered absorbent pad according to an embodiment.

FIG. 8 is a cross sectional view of an illustrative reservoir and multi-layered absorbent pad with a cross sectional view of an illustrative holding vessel according to an embodiment.

FIG. 9 is a cross sectional view of an illustrative multi-layered absorbent pad according to an embodiment.

FIG. 10 is an illustrative method for filling an apparatus according to an embodiment.

FIG. 11 is an illustrative method for providing liquid from within the reservoir to the multi-layered absorbent pad according to an embodiment.

FIG. 12 is an illustrative method for receiving at least a portion of the multi-layered absorbent pad to within a storage vessel according to an embodiment.

FIG. 13 is an illustrative method for swiping the apparatus across material to clean and/or gather hair according to an embodiment.

FIGS. 14-20 are design views of the engaged apparatus according to an embodiment.

### DESCRIPTION

This disclosure is submitted in furtherance of the constitutional purposes of the U.S. Patent Laws “to promote the progress of science and useful arts” (Article 1, Section 8).

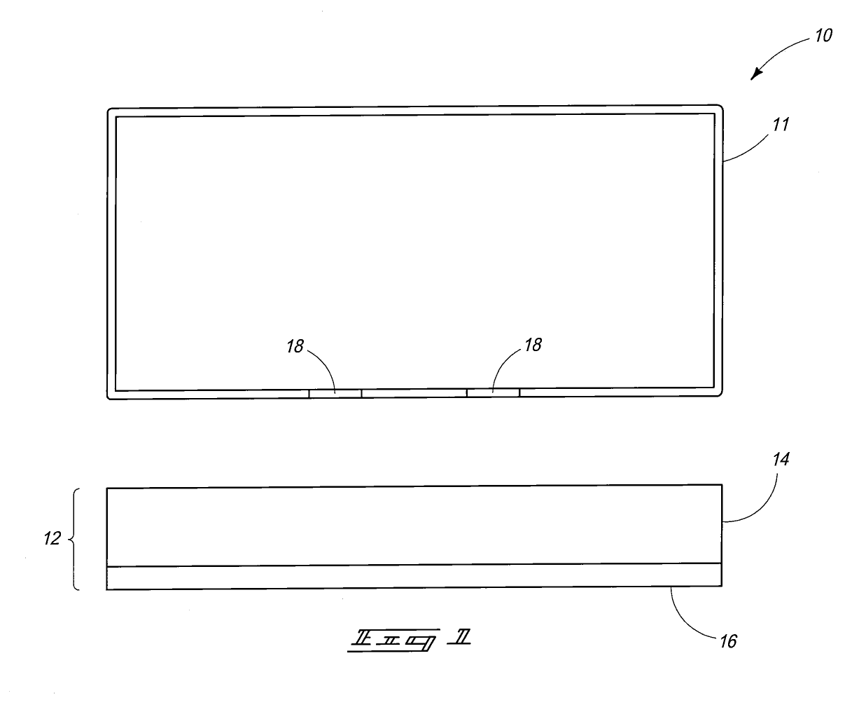

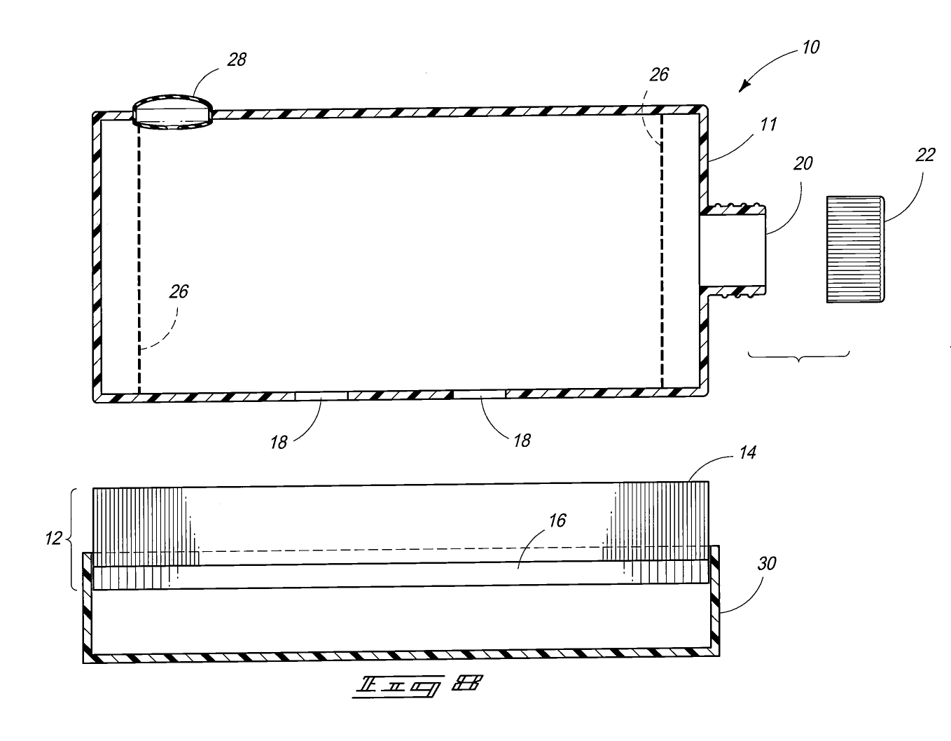

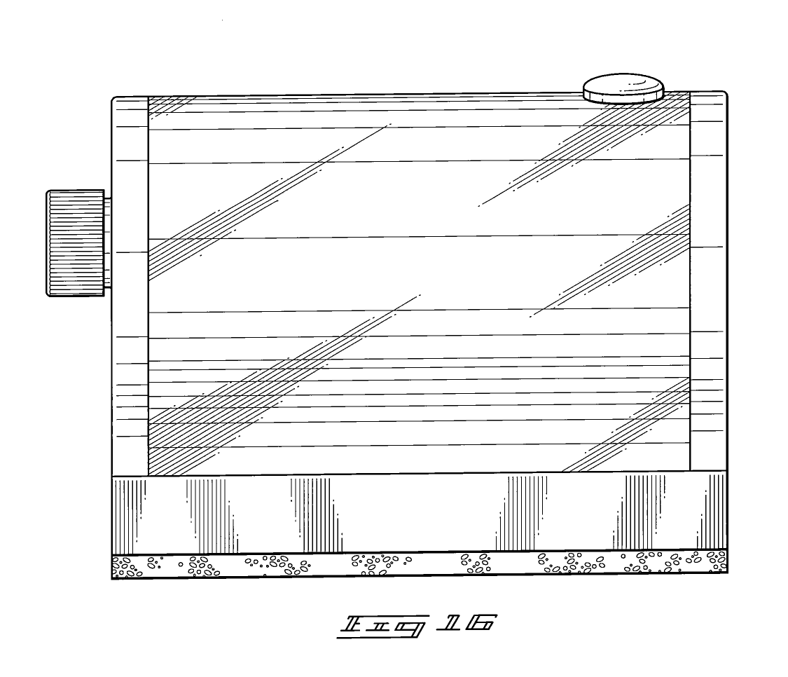

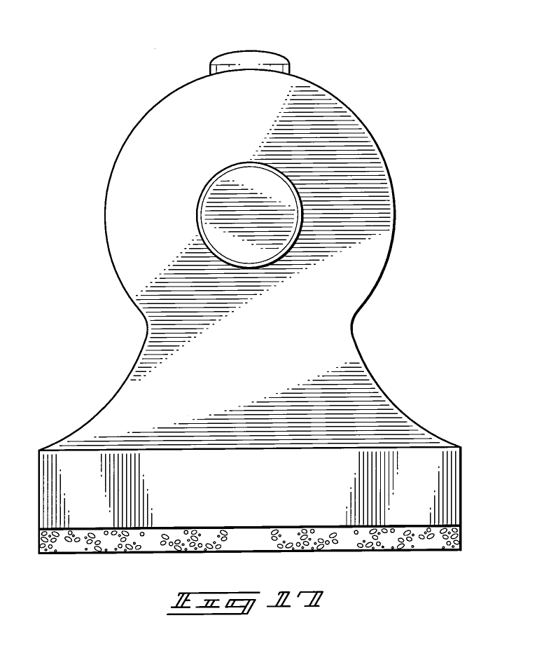

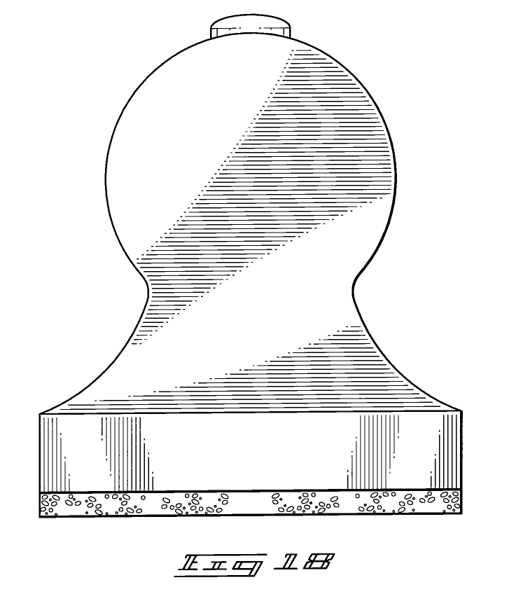

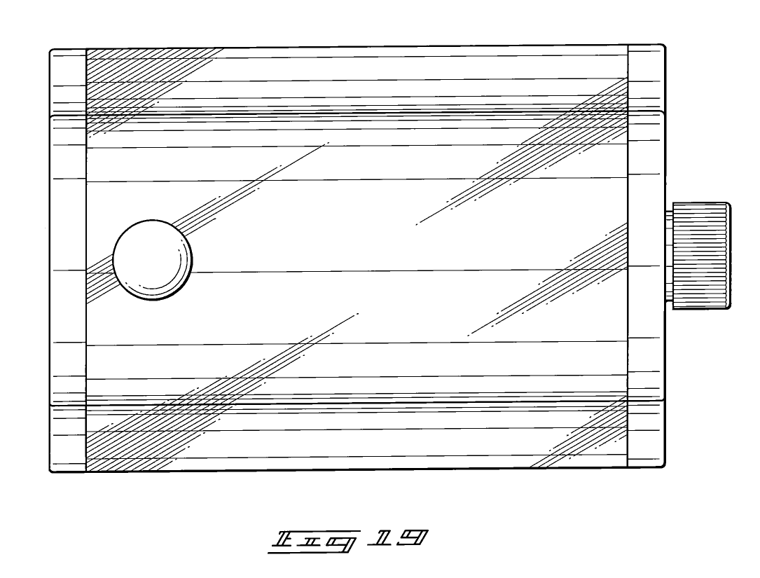

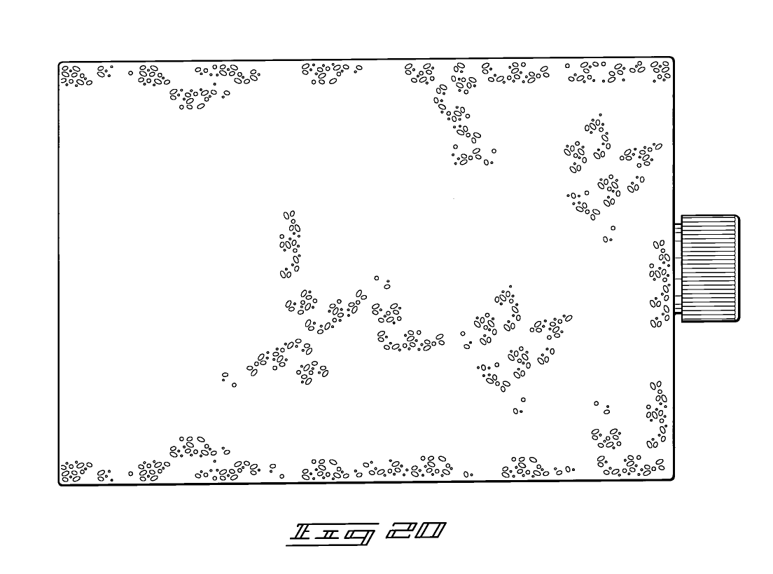

The apparatuses, methods, and designs of the present disclosure are described with reference to FIGS. 1-20. Referring first to FIG. 1, apparatus 10 is shown that includes component 11 and can be configured as a reservoir capable of receiving, storing, and dispersing liquids. Apparatus 10 can also include component 12 that can be configured as a multi-layered absorbent pad. Component 12 can comprise at least two layers, component 14 and component 16. According to example embodiments, component 14 can be configured as a substantially rigid material and component 16 can be configured as a less rigid material than component 14. Either or both of components 14 and 16 can be comprised of an absorbent polymeric material. Component 11 can be comprised of a rigid, translucent polymeric material that can be resistant to degradation by organic chemicals. Additionally, component 11 can be configured as a handle that provides support for component 12 when the apparatus is used for cleaning and/or hair gathering. According to example embodiments, any and all components of apparatus 10 can also be described as elements or members.

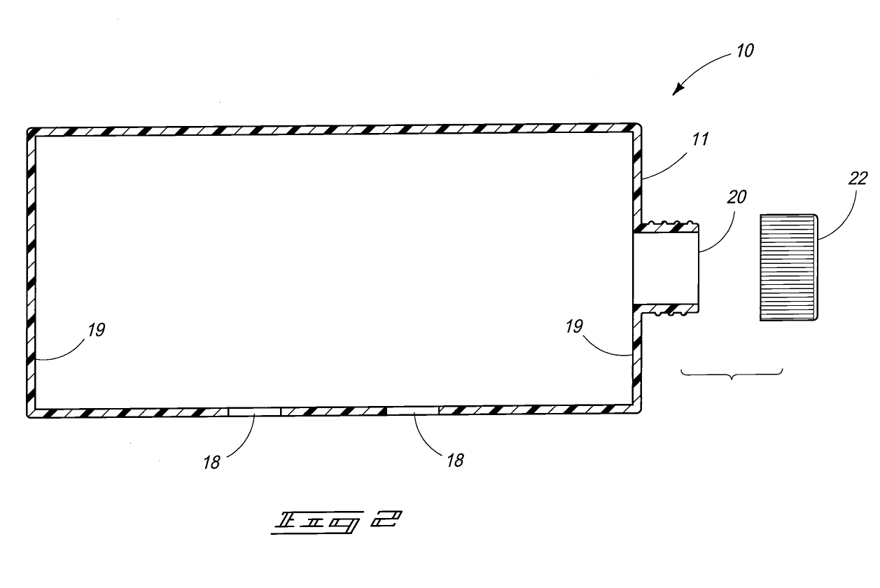

Referring next to FIG. 2, according to another implementation, apparatus 10 is shown, including component 11. According to an example embodiment, component 11 can include lateral walls 19. At least one of the lateral walls 19 can define opening 20 capable of receiving liquids. Opening 20 can be configured as a threaded female joint that can receive a cap. According to example implementations, component 11 of apparatus 10 can also include component 22 that can be configured as a cap to seal opening 20.

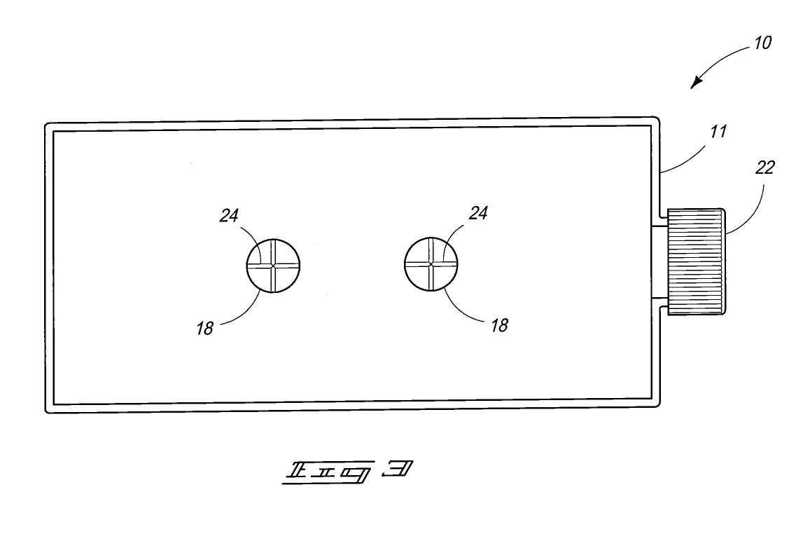

Referring next to FIG. 3, the underside of component 11 is shown including openings 18. In accordance with example implementations, openings 18 can be configured as a multi-channeled exit port having one-way-opening slits 24 that can at least partially open. Slits 24 can be comprised of a substantially flexible material that opens when adequate pressure is applied to within component 11, allowing liquid from within the reservoir to exit from the reservoir until pressure equilibrates.

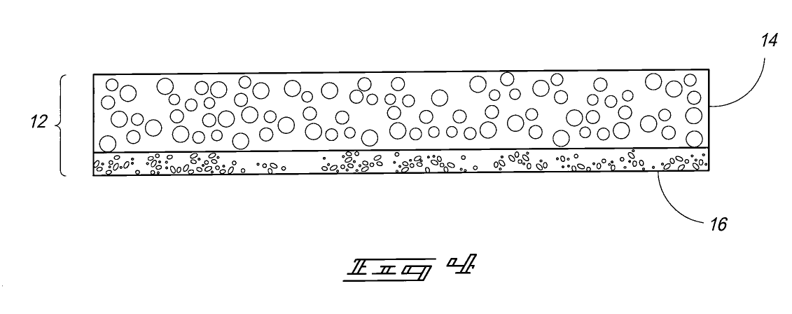

Referring next to FIG. 4, component 12 is shown that includes components 14 and 16. According to example implementations, component 14 can be configured as a substantially rigid, and/or highly porous material. Also according to example implementations, component 16 can be configured as a less rigid, and/or less porous material than that of component 14. Component 14 can be configured to receive liquid from component 11 and disperse that liquid throughout a majority of component 14. According to example implementations, component 14 can also disperse liquid from component 11 to component 16, allowing a majority of component 16 to receive the liquid. Component 14 can also be configured to have a greater rate of absorption than that of component 16, allowing liquid to pass freely through component 14 and into component 16. The lesser rate of adsorption of component 16 can allow liquid to be retained within component 16 until adequate pressure is applied to component 16. According to example implementations, the interface between component 14 and component 16 can be intermingled so that components 14 and 16 are not separate and distinct layers.

Components 14 and 16 can also be compressible and/or permeable. Component 16 can be configured to compress at a rate greater than that of component 14. The greater compressibility of component 16 can allow retained liquid from within component 16 to be released with less pressure than that of component 14. Both components 14 and 16 may be configured to compress under pressure and expand when pressure is released. According to example implementations, component 16 can be configured to compress under less pressure than that of component 14.

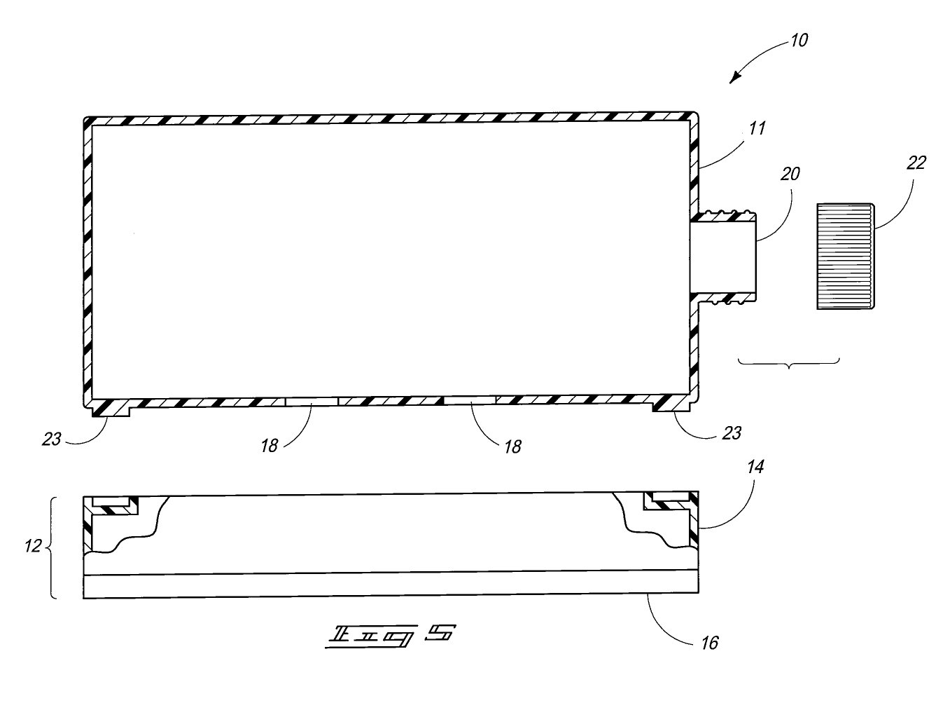

Referring next to FIG. 5, apparatus 10 is shown as well as component 12. Component 11 can include components 23 that can be configured as a plurality of members extending outwardly from the surface defining openings 18 to the reservoir, which can be received by component 12. Components 23 can provide a mechanism for attachment of component 11 to component 12. Components 23 can also be configured to release component 11 from component 12, allowing either component to be replaced as needed.

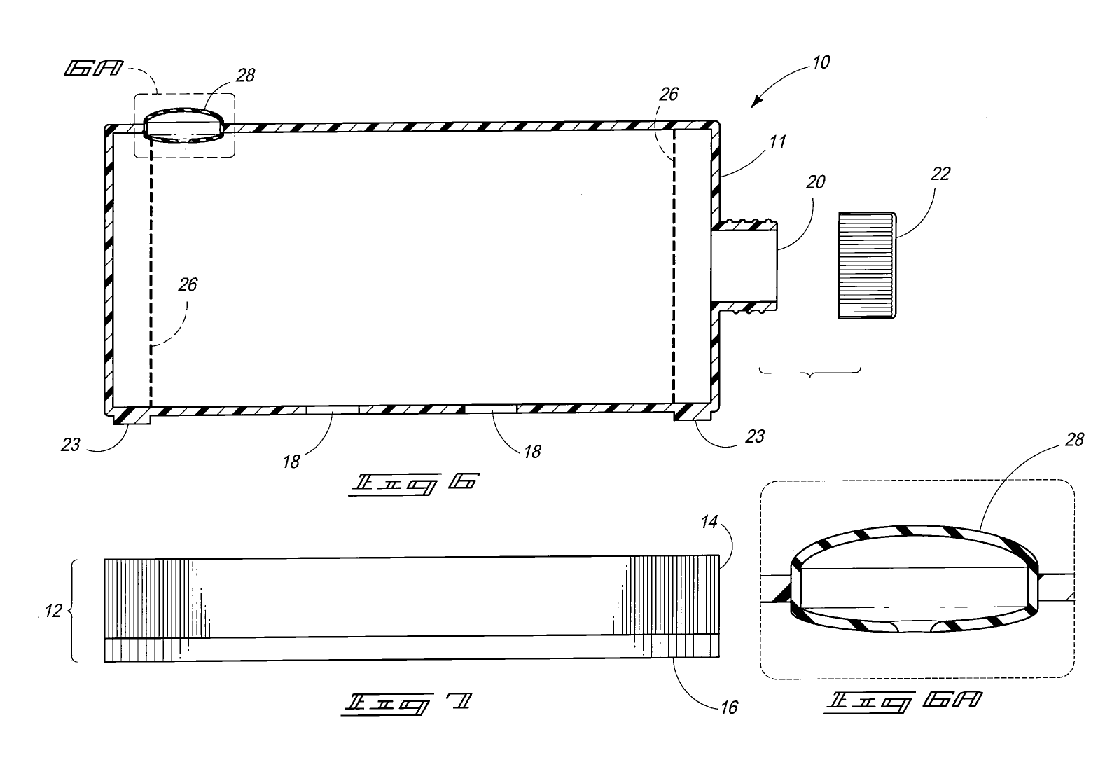

Referring next to FIG. 6, component 11 is shown that can include at least one demarcation 26 and one flexible biased member 28. According to example embodiments, demarcations 26 can be visually observable from outside of component 11. Demarcations 26 can be utilized during the filling procedure of apparatus 10 to provide a method of measuring cleaning solution and water and/or other liquid to within component 11, the cleaning solution and water and/or other liquid being combined to provide an aqueous cleaning solution.

According to example embodiments, flexible biased member 28 can be configured to provide a pressure differential within component 11 when forced to an anti-biased position. Flexible biased member 28 can be forced to an anti-biased position by applying force to at least a portion of the member. When pressure is released, flexible biased member 28 can return to its original biased position and relieve pressure from within component 11. According to an example embodiment, flexible biased member 28 can be located laterally of a centerline of component 11 in one cross section. The location of flexible biased member 28 can diminish the likelihood of accidental force being applied to flexible biased member 28 when component 11 is used as a handle.

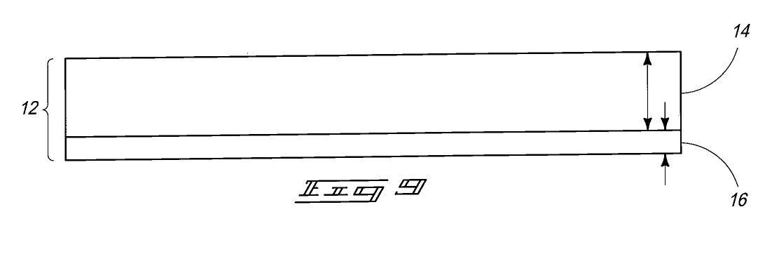

Referring next to FIG. 8, component 11 and component 12 are shown. Also shown is component 30 that can be configured as a vessel to receive at least a portion of component 12 and/or component 11. Component 30 can be defined as an open box that can hold liquids and can keep component 12 from drying for some time. Additionally, component 30 can be implemented as a storage device to protect component 11 and/or component 12 from drying out or from potential environmental wear and tear. Keeping component 12 from drying can allow component 12 to be used quickly when needed for cleaning and/or hair gathering. Additionally, component 30 can prevent unused liquids from within component 12 from evaporating, thus diminishing the possibility of wasting aqueous cleaning solution.

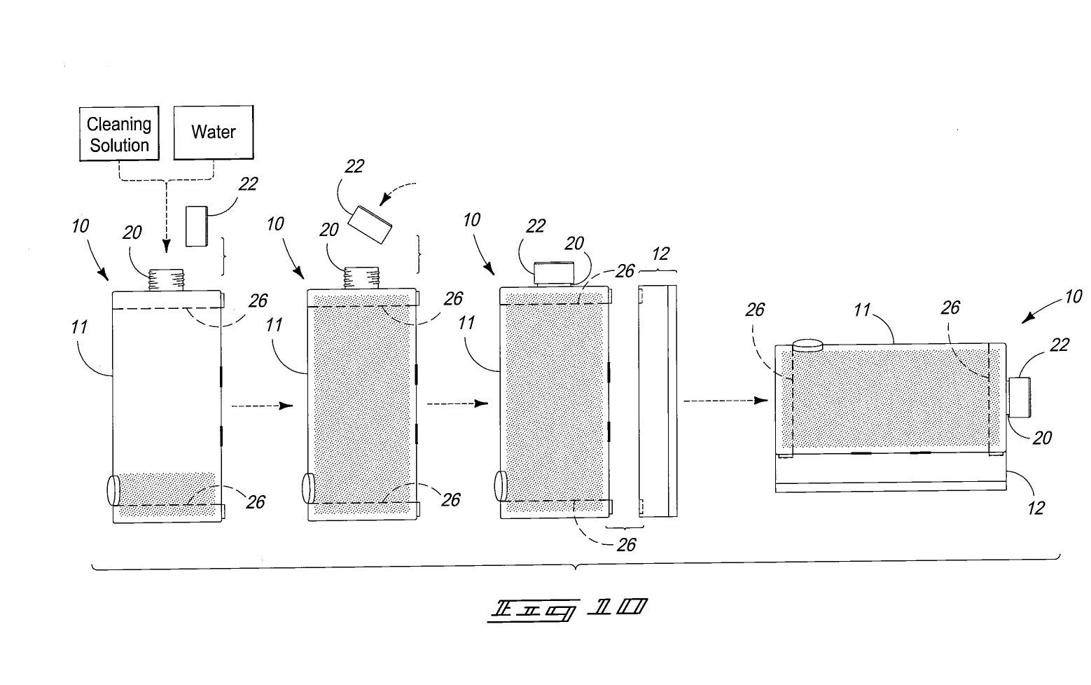

Referring next to FIG. 9, an embodiment of component 12 is shown that can include components 14 and 16. According to an example embodiment, component 14 can be configured to be at least twice the thickness of component 16 in one cross section. The greater thickness of component 14 can provide a sturdier base for component 16 when the latter is swiped across furniture and other materials during cleaning. The thickness of both component 14 and 16 can allow liquid to be absorbed and retained within each component. Component 16 can also expand when adequate liquid is provided and can retract when external pressure is applied. Both component 14 and 16 may be compressible, but component 14 can be configured to be less compressible than component 16 to provide a more solid base for component 16.

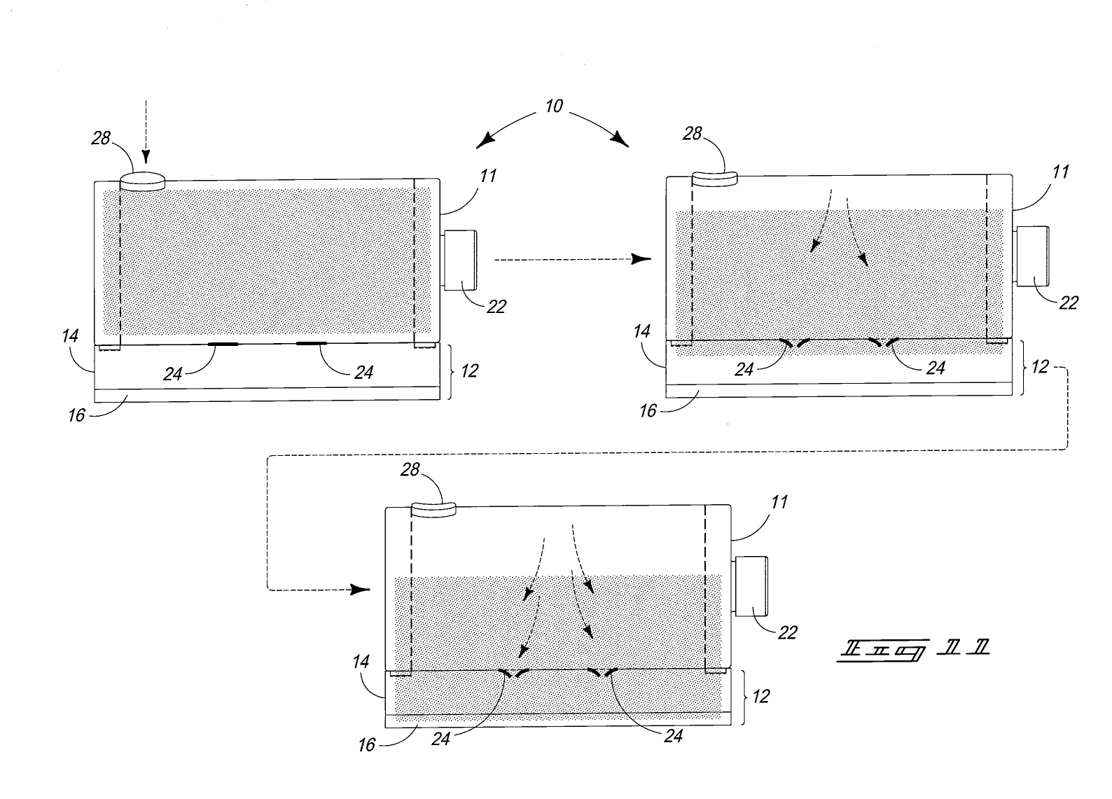

Referring next to FIG. 10, methods for the filling procedure of apparatus 10 are shown. According to example implementations, apparatus 10 can be placed upon one of its lateral walls with opening 20 facing upward. Aqueous cleaning solutions can be received by component 11, using the visual demarcations 26 to facilitate a proper ratio of cleaning solvent to water and/or other liquid. Once a desired amount of aqueous cleaning solution has been added to component 11, cap 22 can be placed over opening 20 to substantially seal opening 20. Component 12 can then be attached to component 11. Apparatus 10 can then be rotated so that component 12 becomes the base of the apparatus and component 11 sits on top of component 12. The aqueous cleaning solution within component 11 can remain inside the reservoir until cleaning and/or hair gathering is desired.

As an alternative to using an aqueous cleaning solution as the cleaning solution to be received with component 11, other liquids can also be used. For example, some stains react more readily with more polar organic solvents such as ethanol. Component 11 can be configured to be chemically resistant to a wide range of chemical polarities and chemical make-ups to receive and store such chemicals within the reservoir for a period of time.

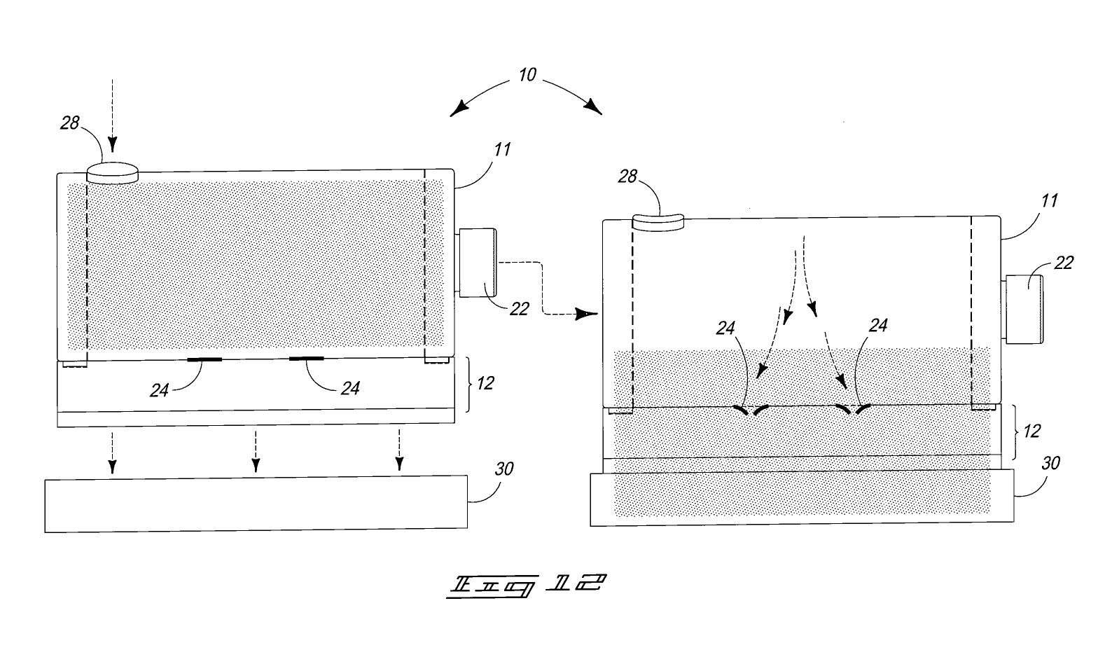

Referring next to FIG. 11, methods for dispersing liquids from component 11 to component 12 are shown. According to example implementations, liquids can be dispersed from component 11 to component 12 by forcing flexible biased member 28 to an anti-biased position within component 11, substantially increasing pressure within component 11. The increased pressure within component 11 can provide enough force to within the reservoir to at least partially open slits 24. When slits 24 are at least partially open, the liquid from within component 11 can flow from the reservoir to component 12. Liquid forced from component 11 can flow first to component 14 of component 12. Component 14 can be configured as a substantially rigid, highly porous, and/or substantially thick material that readily disperses the liquids from component 11 throughout a majority of component 14. At least a portion of the liquid from within component 14 can then flow to component 16 of component 12. A portion of the liquid can remain within component 14 as another portion of the liquid flows to component 16. Component 16 can be configured as a less rigid, less porous, and/or thinner layer than component 14 and can readily absorb and retain liquids received from component 14. Additionally, component 16 can be configured to have a lesser rate of dispersion than component 14, which can allow component 16 to store liquids more readily than component 14. Both components 14 and 16 can be configured to be compressible, but component 16 can be configured to be substantially more compressible than component 14. According to example implementations, the compressibility and/or permeability of component 16 can allow liquids retained by component 16 to be expelled from component 16 when adequate external pressure is applied to component 16.

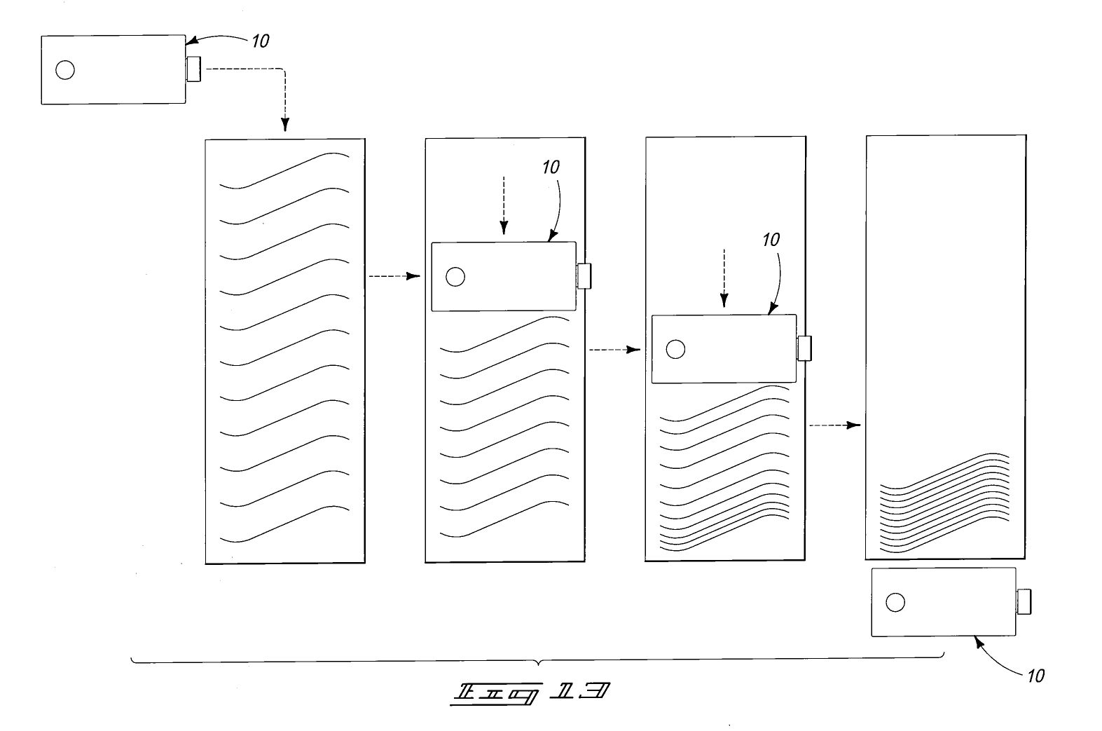

Referring next to FIG. 12, methods for apparatus 10 being received by vessel 30 are shown. Component 11 can be attached to component 12 and component 11 can be filled with cleaning solution. Component 12 can have retained liquids within it or be substantially dry. At least a portion of component 12 and/or component 11 can be received to within vessel 30, vessel 30 providing storage for apparatus 10 when not in use. Where component 12 has retained liquids within it, vessel 30 can provide a moist environment for component 12 and hinder the same from drying. By keeping component 12 damp, cleaning and/or hair gathering can be accomplished without dispensing more liquid from within component 11, thereby reducing wasted liquid and increasing the efficiency of the apparatus for cleaning and/or hair gathering.

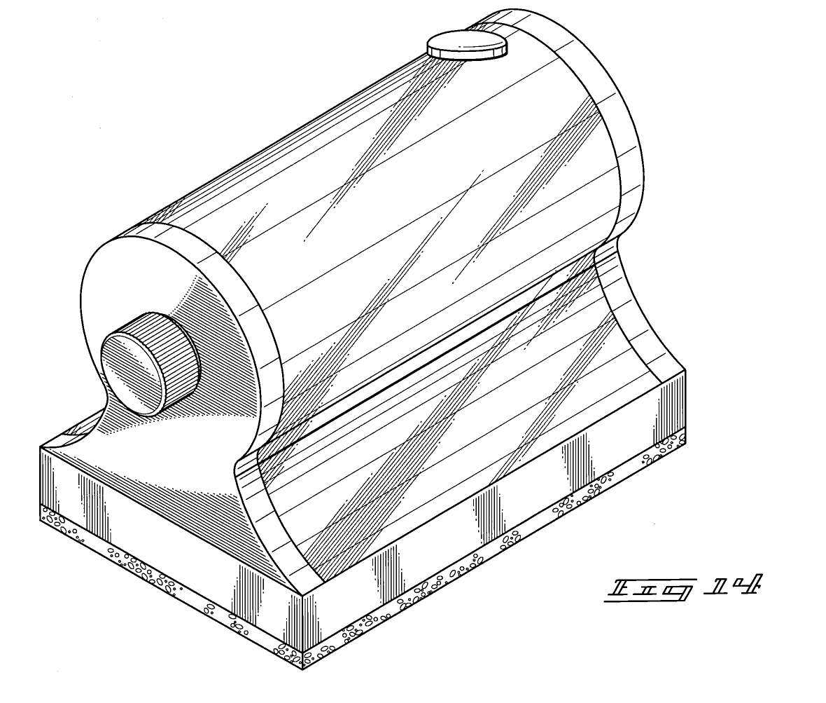

Referring next to FIG. 13, methods for cleaning are shown. Apparatus 10 including, for example, component 16 can be placed upon materials to be cleaned and pressure can be applied to those materials. The applied pressure can compress component 16 and force retained liquids from within component 16 to materials to be cleaned. When a desired amount of liquid has been applied to materials to be cleaned, pressure on those materials can be released and the liquid absorbed back into component 16 as it retracts and decompresses.

Alternatively, component 16, having retained liquids, can be swiped across materials to be cleaned, leaving the materials at least partially damp. This method of cleaning can allow liquids from component 16 to remain on materials to be cleaned for a greater period of time, allowing the liquids to react with stains on materials to be cleaned. Once a desired amount of time has passed, component 16 can be swiped back across the materials to be cleaned. The absorbent nature of component 16 can absorb the liquids from the cleaned materials to component 16 to be disposed of.

Additionally, FIG. 13 illustrates at least one method for the gathering of hair. Component 16, having retained liquids from component 11, can be swiped across materials to remove hair. Component 16 can substantially attract hair from materials by providing greater friction between component 16 and the hair than between the hair and the materials to be cleaned. The liquid retained within component 16 can be released from component 16 to the hair on materials to be cleaned when component 16 is swiped across the surface of the materials to be cleaned. The transferred liquid on the hair can substantially hinder expulsion of the hair from the materials to be cleaned into the surrounding air. The dampness of the hair and the friction created between the hair and component 16 can allow hair to be gathered together when component 16 is swiped across materials to be cleaned. The gathered hair can then be disposed of without it being expelled into the surrounding air for example. Any hair that may have stuck to component 16 during the gathering process may be removed by the operator and component 16 can be used again for gathering hair.

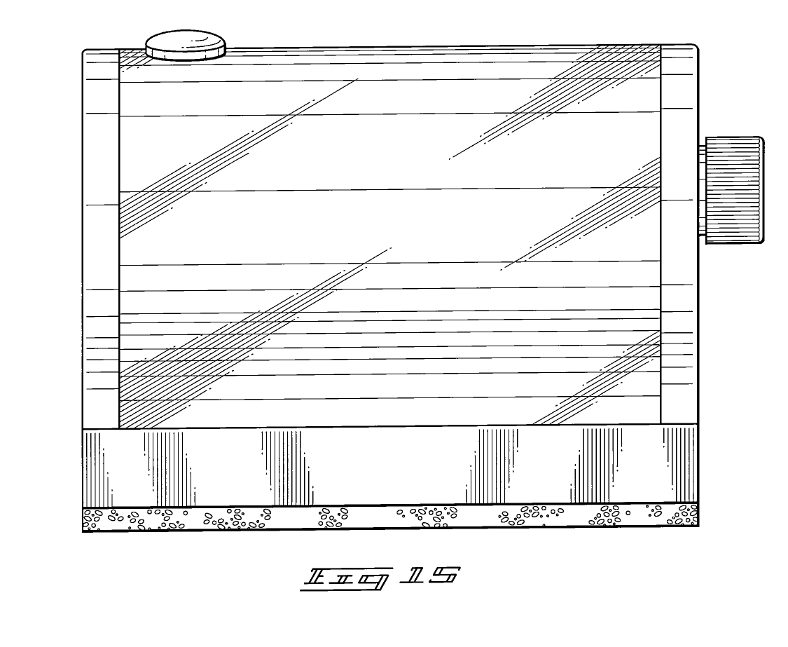

Referring next to FIGS. 14-20, a design for a cleaning apparatus is shown.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

The invention claimed is:

1. A cleaning and/or hair gathering apparatus, the apparatus comprising:
first and second components configured to form a liquid dispenser and define a reservoir when operatively engaged; and
wherein the second component is configured as a multi-layered absorbent pad, wherein one of the layers of the pad comprises a substantially rigid material, and another layer of the pad comprises a less rigid material than the first layer.

2. The apparatus of claim 1 wherein the one layer comprises a relatively high porosity material and the other layer comprises a less porous material.

3. The apparatus of claim 1 wherein the one layer comprises a material at least twice the thickness of the other layer in one cross-section.

4. The apparatus of claim 1 wherein the reservoir defines at least one opening, the opening housing a multi-channeled exit port having one-way-opening slits that at least partially open when adequate pressure is applied to within the reservoir.

5. The apparatus of claim 1 wherein the reservoir defines at least two demarcations, the demarcations being visually observable from outside the reservoir.

6. The apparatus of claim 1 further comprising a vessel, the vessel configured to receive at least a portion of the multi-layered absorbent pad and retain liquids.

7. The apparatus of claim 1 further including a flexible biased member in fluid communication with an interior of the reservoir, the member configured to provide a pressure differential when forced to an anti-bias position.

8. The apparatus of claim 7 wherein the flexible biased member is located laterally of a centerline of the reservoir in one cross section.

9. The apparatus of claim 1 wherein the reservoir comprises a member connecting two lateral walls, at least one of the walls defining at least one opening, the opening structurally configured to receive a cap to substantially seal the opening.

10. The apparatus of claim 1 wherein the interface between the one layer and the other layer of the multi-layered absorbent pad is intermingled.

11. A cleaning method comprising:
applying pressure to within a liquid-dispensing reservoir to force liquid from the reservoir to one substantially rigid layer and then to another less rigid layer of a multi-layered absorbent pad; and
applying the less rigid layer to material to be cleaned.

12. The method of claim 11 wherein applying pressure to within a liquid-dispensing reservoir forces liquid from the one layer to the other, the one layer being substantially more porous and having a higher rate of dispersion than the other layer.

13. The method of claim 11 wherein the applying the less rigid layer to material to be cleaned at least lightly dampens the material, the other layer absorbing the liquid from the dampened material when that the less rigid layer is reapplied to the material.

14. The method of claim 11 further comprising providing liquid solutions to within the reservoir, the providing comprising supporting the reservoir by one lateral edge of the reservoir and providing liquid through an opening in another lateral edge opposing the one lateral edge.

15. The method of claim 11 wherein the applying the pressure to within the reservoir comprises applying pressure to a flexible biased member of the reservoir, the flexible biased member compressing to within the reservoir and substantially creating a pressure differential within the reservoir when forced to anti-bias.

16. The method of claim 15 wherein the applying the pressure to within the reservoir comprises disperses liquid from the reservoir to a majority of the one layer, the one layer further dispersing liquid to the other layer and then to materials for cleaning.

17. The method of claim 16 wherein the applying the less rigid layer comprises swiping across the surface of the materials to be cleaned, the other layer substantially attracting hair from materials by providing greater friction between the other layer and the hair than between the hair and the materials for cleaning.

18. The method of claim 16 wherein applying the less rigid layer comprises transferring liquid from the other layer to hair on material to be cleaned when the other layer is compressed, the transferred liquid substantially hindering the expulsion of hair from materials for cleaning into the surrounding air.

19. The method of claim 16 wherein the other layer is compressible and permeable, the other layer providing aqueous cleaning solution to stained materials when compressed and absorbing cleaning solution from stained materials when decompressed.

20. A cleaning apparatus design as shown in FIGS. 14-20.
